(19) United States
(12) Patent Application Publication
(10) Pub. No.: US 2016/0350767 A1
(43) Pub. Date: Dec. 1, 2016

(54) Wireless Spectrum Price Discovery

(71) Applicant: Jesse M. Caulfield, McLean, VA (US)

(72) Inventor: Jesse M. Caulfield, McLean, VA (US)

(21) Appl. No.: 14/727,616

(22) Filed: Jun. 1, 2015

(51) Int. Cl. G06Q 30/02; H04M 15/00

(52) U.S. Cl. CPC G06Q 30/0201; H04M 15/80

(57) ABSTRACT

This disclosure describes a novel method for price discovery of a spectrum license. Calculated metrics and other local information may be combined with previous transaction prices to calculate a fair market value. The published market value of one license may be updated according to a feedback mechanism influenced by transactions of other licenses. The invention enables a market-making party to establish an objective fair market price and to support single-bid or sparse-bid spectrum auctions.

### CROSS-REFERENCE TO RELATED APPLICATIONS

Not Applicable.

### FIELD OF THE INVENTION

The present invention relates generally to valuing a license for a radio frequency band of the electromagnetic spectrum as an intangible asset and, more particularly, to a system and method for establishing a spectrum license value in a secondary market having sparse price information.

### BACKGROUND OF THE INVENTION

The use of radio frequency bands of the electromagnetic spectrum (spectrum) is generally authorized worldwide under two regimes: unlicensed and licensed. Unlicensed spectrum use generally permits an application to operate without a license and also without exclusivity or interference protection from another unlicensed application. Examples of unlicensed use include garage door openers, in-home networking (WiFi), microwave ovens, and citizen's band (CB) radios. Licensed spectrum use generally permits an application to operate with either exclusive use of a radio frequency band or, in a spectrum sharing environment, with an obligation to coordinate with another licensed application but always with a right to interference protection from another unlicensed application. Examples of licensed use include over-the-air radio and television broadcast, land mobile radio, and cellular network systems.

A spectrum license is typically defined as permission given by a government agency to an entity that provides that entity (the licensee) an exclusive right to use a radio frequency band for a particular application. In a spectrum sharing environment the licensee's exclusivity may be relaxed to a right to use a radio frequency band free of interference. Spectrum licenses are usually designated for a specific geographic area or region, such as a defined service area, a metropolitan region, a census block, but may also extend to the entire nation for which the issuing government agency has jurisdiction. In summary: a spectrum license typically grants exclusive or protected use of a frequency band throughout a defined geographic area. For example, in the United States a television broadcast licensee may exclusively use a 6 MHz block of spectrum throughout a geographic region defined as the extent within which the licensee's intended audience is able to successfully receive the transmission.

A spectrum license is an intangible property right, the components of which may be partitioned and leased or resold through a secondary market. For example, a license owner may not require the use of their radio frequency band during certain hours of the day and may sell the right to use their spectrum during this “off-hours” period to another party. In this case the other, buying party becomes the licensed user during its period of use. Other aspects of a spectrum license, including, for example, the frequency, geographic region, etc. may be similarly partitioned and traded through a secondary market.

In the United States the Federal Communications Commission (FCC) issues spectrum licenses for non-federal use through, among other means, a system of competitive bidding (e.g. an auction) where mutually exclusive applications exist for a given wireless spectrum. It may occur in a spectrum auction that only one wireless service provider bids for a particular license configuration and, because no mutually exclusive application exists, the FCC may award no licenses at any price. In this scenario the auction has failed: the buyer does not receive a potentially critical asset for their business and the seller receives no revenue. While such an auction failure may prevent a single low bidder from exploiting a desperate seller both parties may be damaged if the offered single bid was reasonable and fair.

Accordingly, a method is needed for price discovery in a sparse auction that establishes an objectively fair value for the seller and also enables transaction closure for the buyer.

### BRIEF SUMMARY OF THE INVENTION

A method is provided to establish objective spectrum license value estimation based upon sparse price information and other localized datasets.

### BRIEF DESCRIPTION OF THE DRAWINGS

Many aspects of the present disclosure can be better understood with reference to the following drawings. The drawings serve to further illustrate various embodiments and to explain various principles and advantages of the present invention. The components in the drawings are not necessarily to scale, emphasis instead being placed upon clearly illustrating the principles of the disclosure.

FIG. 1 is a flow chart presenting various known and described strategies for the creation, issuance, use, transfer and exchange of a spectrum license.

FIG. 2 depicts the geographic distribution of sold and unsold licenses in a primary spectrum auction.

FIG. 3 is a flow diagram and process for a secondary spectrum market implementation designed to operate with sparse price information.

FIG. 4 is a flow diagram describing how to assign and/or update a spectrum license price using past transactions, calculated metric information and localized datasets.

FIG. 5 depicts a scenario where several spectrum licenses have been sold and a triangulation strategy is established between the transacted licenses.

FIG. 6a and FIG. 6b together depict geographic partitioning strategies where each partitioned area has an associated local value.

FIG. 7 depicts a geographic partitioning strategy where each unpriced partitioned area is assigned a price using methods of the immediate invention.

FIG. 8 describes the results from a linear interpolation strategy.

FIG. 9 visualizes how a multi-variate interpolation strategy may be established over a large number of partitioned license areas.

### DETAILED DESCRIPTION OF A PREFERRED EMBODIMENT

As will be demonstrated by the various provided examples the implementation of spectrum license price discovery will benefit from and may require a method and implementation that incorporates information from a primary and secondary market, plus geographically local data.

This disclosure describes a novel method for facilitating spectrum license transactions in an auction having few bidders and where pricing information may be sparse and geographically distributed. The invention described herein enables a market-making party to establish an objective fair market value in single-bid or few-bid spectrum auction. Furthermore, the established market value of a spectrum license offered in one geographic region may be updated according to a feedback mechanism influenced by transactions in other regions.

The disclosure and various features and advantageous details thereof are explained more fully with reference to the exemplary embodiments illustrated in the accompanying drawings and detailed in the following description. Descriptions of known programming techniques, computer software, hardware, operating platforms and protocols may be omitted so as not to unnecessarily obscure the disclosure in detail. The detailed description and the specific examples, while indicating the preferred embodiments, are given by way of illustration only and not by way of limitation. Various substitutions, modifications, additions and/or rearrangements within the spirit and/or scope of the underlying invention will become apparent to those skilled in the art from this disclosure.

The provided examples are furthermore not intended as restrictions or limits to terms with which they are utilized. Instead the examples or illustrations are intended to describe a particular embodiment for illustrative purposes. Those of ordinary skill in the art will appreciate how the provided examples or illustrations encompass other embodiments and such embodiments are intended to be included within the scope of this invention.

In the United States responsibility for all non-federal spectrum licensing is assigned to the FCC, which prefers to assign spectrum use licenses through a public auction. In other countries the national telecommunications regulator typically maintains a similar responsibility and often implements a similar strategy for spectrum license assignment. In the United States and also in many other countries a secondary market exists wherein spectrum licensees may sublease or sell spectrum rights for use by other parties.

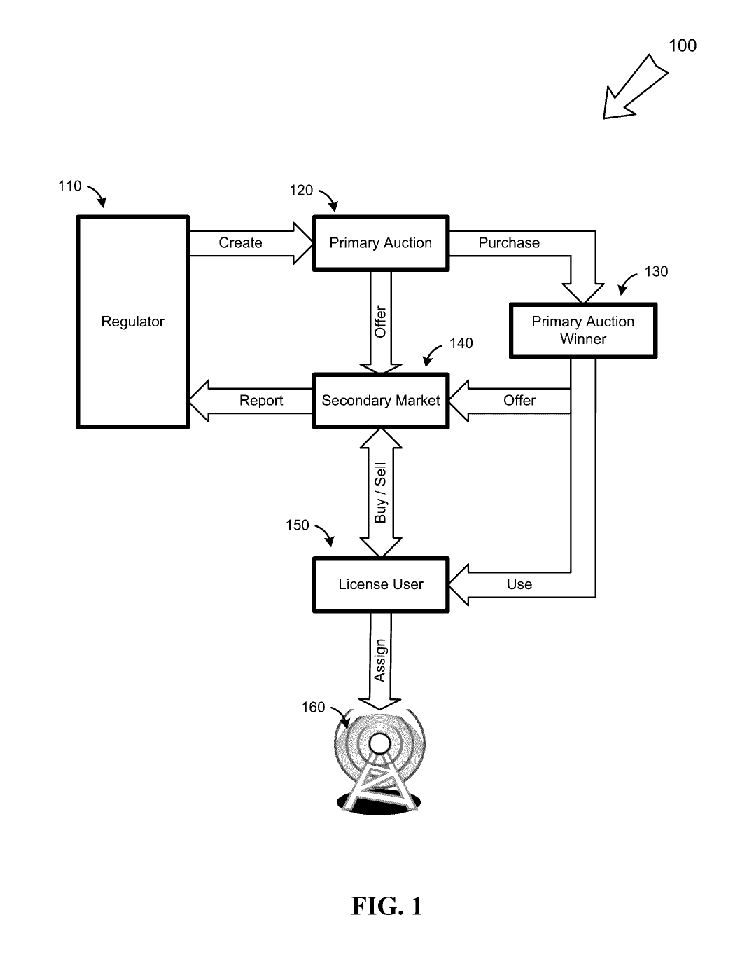

FIG. 1 is a flow chart presenting various known and described strategies for the creation, issuance, use, transfer and exchange of spectrum license rights. According to various known methods summarized in 100 a regulator 110 may create an initial inventory of spectrum licenses and offer this inventory for sale via a primary public auction 120. Through the auction 120 a plurality of private parties 130 may purchase a plurality of spectrum licenses and hold the licenses as an intangible asset, put the licenses to use by one or more license user 150 or offer the licenses to other private parties on a secondary market 140. Often the licensed user 150 is closely related or even the same party as the primary auction winner 130. This is not required however.

A license user 150 may exploit the license by offering a variety of wireless services 160 using the spectrum described in the license. Examples of wireless services 160 may include, for example, two-way paging, microwave, network backhaul, cellular telephony, cellular data, broadcast radio and television, land mobile radio, and so forth.

If the license user 150 does not need their issued license they may sublease or sell the license via a secondary market 140. Similarly the user 150 may also acquire additional licenses from a secondary market 140. Through buying and selling spectrum licenses the license user 150 may manage and groom their spectrum holdings to better align with their geographic markets served and services offered.

In various described embodiments of a secondary spectrum market 140 a mechanism is included to report the various license transactions back to the regulator 110. In some descriptions the primary license holder 130 is assigned this responsibility, in others the license user 150, and in others the market itself 140. For clarity only one reporting strategy is shown.

Referring again to FIG. 1, in the event that not all licenses are sold in a primary auction 120 a regulator may wish to offer the unsold license inventory via a secondary market 140. While such an occurrence may be rare since spectrum license demand typically exceeds supply it is certainly possible and envisioned in this and other inventions.

There are numerous instances of primary public spectrum auctions 120 wherein a regulator organizes a spectrum band into a finite inventory of licenses that sell out completely. One such example is FCC Auction 97 (“AWS-3”) where 65 MHz of spectrum was partitioned by the regulator into 1,614 licenses and offered for sale through a simultaneous multi-round auction. There are also instances where the created inventory of licenses do not sell out or are not expected to sell out. One such example is the anticipated FCC auction of the 3,550-3,700 MHz block, where over 500,000 licenses covering 70 MHz of spectrum will be created and offered for sale but are not expected to sell out in the primary auction.

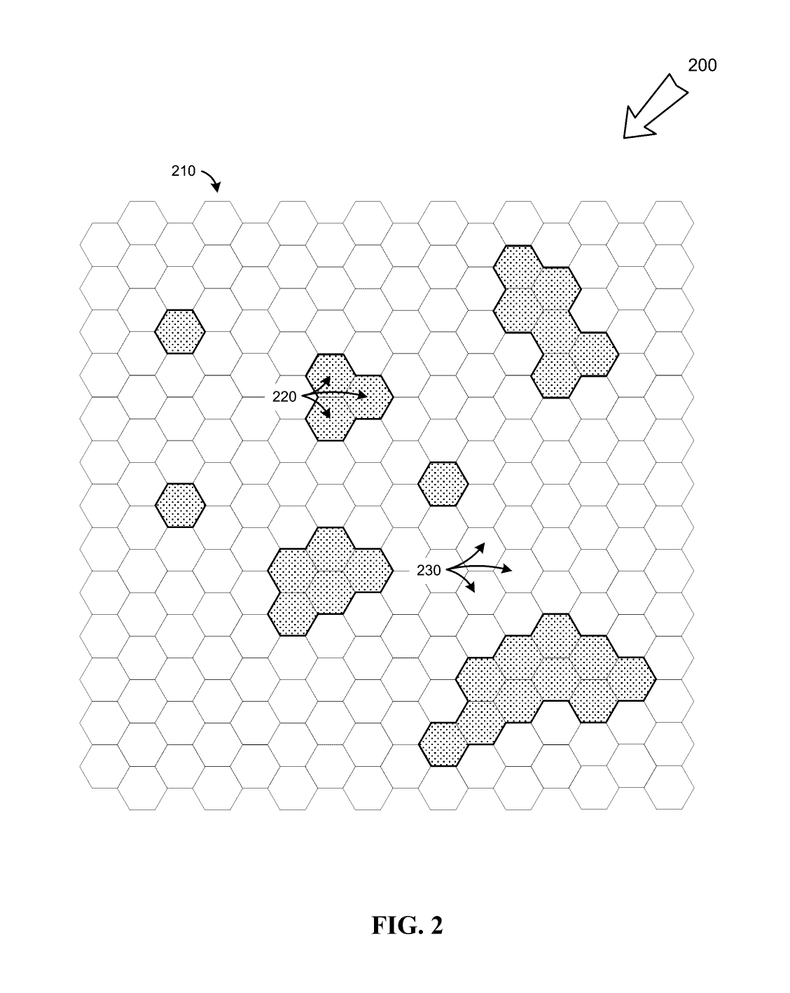

Referring to FIG. 2 a geographic partitioning strategy 200 is shown wherein a plurality of non-overlapping geographic areas 210 is defined. There are many examples of non-overlapping partitioning strategies used to define the geographic extent of a spectrum license. Common geographic partitioning strategies include Basic Trading Areas, Component Economic Areas, Cellular Market Areas, Metropolitan Statistical & Rural Service Areas, Census Tracts and so forth.

Referring to FIG. 1 and to FIG. 2 together and in the context of a spectrum auction, according to an envisioned primary auction result a plurality of spectrum licenses may be offered 210 with a subset of licenses 220 being sold and the balance of licenses 230 remaining unsold. According to an envisioned embodiment the sold licenses 220 may be assigned by the regulator 110 to the respective primary auction winners 130 and the unsold licenses 230 may be re-offered for sale on a secondary market 140.

By definition the unsold licenses 230 will only exist in the event of a failed primary auction which is most likely the result of insufficient bidders or inadequate bidding. The secondary market 140 must therefore implement, and this invention provides, a strategy to rectify this failure by discovering a fair market price for each individual license and thereby accommodating sparse bidders and bids.

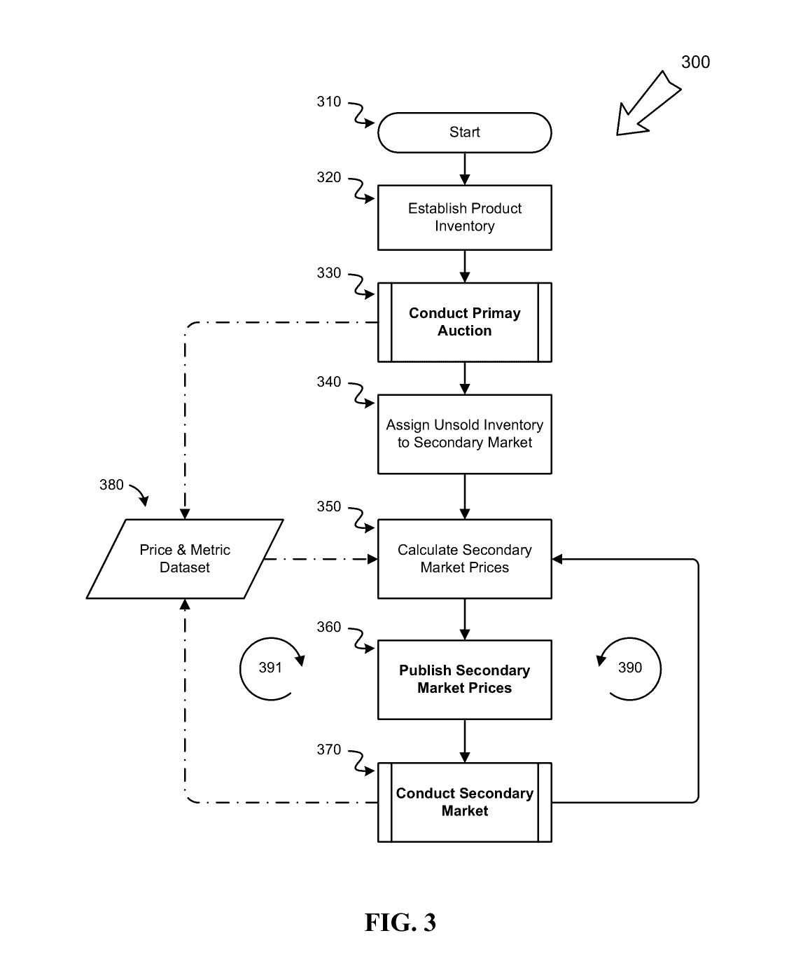

Referring to FIG. 3 a spectrum license price discovery process is shown in flow chart format wherein the market transaction price data, supplemented by other, geographically local information, may be used to first initialize and then to continually update the market price of a spectrum license in a secondary market. The method 300 begins 310 and the regulator may establish a inventory of spectrum licenses 320 according to, for example, a radio frequency band plan and a geographic partitioning strategy. The regulator may then proceed to conduct a primary spectrum auction 330 which may produce a collection of transactions and a corresponding body of geographically partitioned spectrum price information.

The primary market spectrum price information may be combined with other geographically partitioned metric information such as, for example, population and income demographics to create a price and metric information dataset 380.

Following the conclusion of the primary auction 330 the regulator may assign any unsold inventory to a secondary market 340.

According to a preferred embodiment the secondary market may receive the previously initialized price and metric dataset 380 and calculate market prices for each unit of unsold inventory 350. After an initial market price is calculated the price for each license may be published 360 and the licenses offered for sale through the secondary market 370.

When a license is sold through the secondary market the secondary market transaction price may be used to update the market price and metric dataset 380 and thereby also to recalculate the prices of other licenses on the secondary market 350. By this strategy continuous feedback loops 390, 391 may be established wherein each executed transaction may add to the price and metric dataset 380 and also cause the calculated prices for other unsold license inventory to be adjusted closer to each respective license's optimal market value.

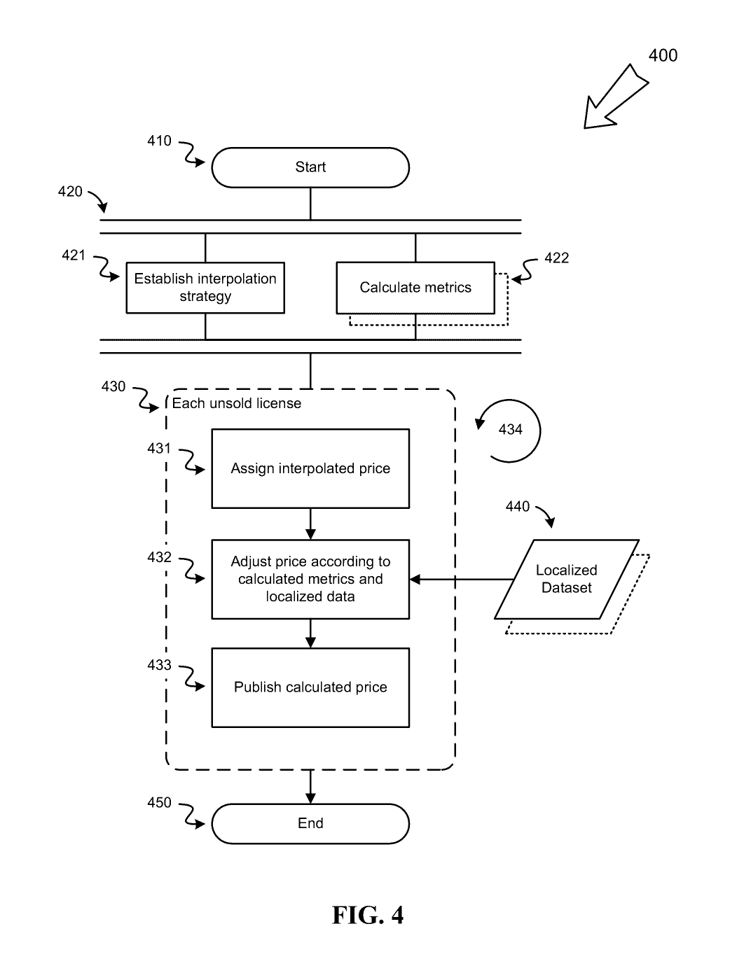

FIG. 4 is a process flow chart of a method to calculate a fair market value for a single spectrum license based on previous transaction prices and other localized data. The method 400 begins 410 and may proceed with one or more initial calculation processes executed sequentially or in parallel 420 according to the preference of the implementation.

One initial calculation of the method 400 is to establish an interpolation strategy using the previous license transaction information 421. A variety of interpolation strategies are available, the selection criterion for which may depend upon the license's geographic partitioning strategy and also the sparsity of available pricing information, among other factors.

Recalling that a license is defined by at least a radio frequency band and a geographic area, according to a preferred embodiment the geographic extent of the primary auction may be partitioned into regions based on distances between centroid coordinates of each transacted license area. This process is analogous to a Delaunay triangulation strategy where points in the triangulated plane may be defined as the centroid coordinates of the various license areas. A single or multi-variate interpolation strategy may then be implemented along the chords of the triangulation or across the two-dimensional surface thus generated.

For example, according to an envisioned embodiment a linear interpolation strategy may by established along the chords of the established triangulation. By this method an estimated price level may be calculated anywhere between the two end point price values using simple linear interpolation.

Referring again to FIG. 4 other initial processes may include the calculation of one or more metric values 422. In a preferred embodiment the metric values 422 may inform and adjust the interpolated price value of a spectrum license. Many useful metrics are known and widely used. One metric developed by industry for rule-of-thumb spectrum price comparison across spectrum bands and markets is called “Price per MhzPop”, which is calculated as follows:

Price per MHzPop=Price/(MHz×Population)

Where the Price is the spectrum license transaction value in dollars, MHz is the total amount of spectrum included in the license, measured in MHz, and Population is the population living or residing within the geographic service area associated with the license.

Regardless of the specific spectrum pricing strategy considered the Price per MHzPop metric is often used to test the reasonableness of the calculated value.

The Price per MHzPop metric may be calculated on a per license basis in which case the value is localized and may indicate whether the transaction price was less or more expensive compared to other spectrum licenses. In the context of the immediate invention the term localized means that the metric value is associated with or has a relationship to a geographic position or area. For example, census population information may be localized to a census tract, median household income may be localized to a county, and so forth.

Alternatively, according to a preferred embodiment, non-localized metrics may also be calculated. For example, a global Average Price per MhzPop metric may be generated by a total or running average of previously recorded transactions and may be used as a market index indicator. Global metrics may be useful both in the direct estimation of a license's value and also as market index indicators.

Referring again to FIG. 4 the interpolation strategy and the one or more metric values may be combined to calculate a market price for each available (e.g. unsold) license 430. In an envisioned embodiment a base price is calculated and assigned to the license according to the selected interpolation strategy 431 (e.g. linear, bilinear, multi-variate, etc.) The assigned base price may then be adjusted up or down according to a calculation 432 that incorporates the previously calculate metrics 422 and one or more localized datasets 440. Localized datasets that may be useful when combined with the calculated metrics include, for example, population census data, econometric data, digital terrain data, and so forth. After adjustment 432 the final calculated price may be published 433. The calculation 430 may be repeated 434 for each offered license until all licenses have been processed, after which the process may end 450.

At a high level the value of a spectrum license (Vₛ) equals the interpolated price from other previous transactions (Vᵢ) plus any global and/or localized value adjustments (Vₐ) from the calculated metrics, where the adjustment may be positive or negative.

Vₛ=Vᵢ+Vₐ

In the method 400 there may be a plurality of value adjustments depending upon the number of metrics 422 and layers within the localized dataset 440. The value adjustment (Vₐ) is therefore the sum of each individual adjustment (Vₐ₁+Vₐ₂+Vₐ₃+ . . . +Vₐₙ) where n is the total number of adjustments and, as before, any particular adjustment may be positive or negative.

Vₐ=Vₐ₁+Vₐ₂+Vₐ₃+ . . . +Vₐₙ

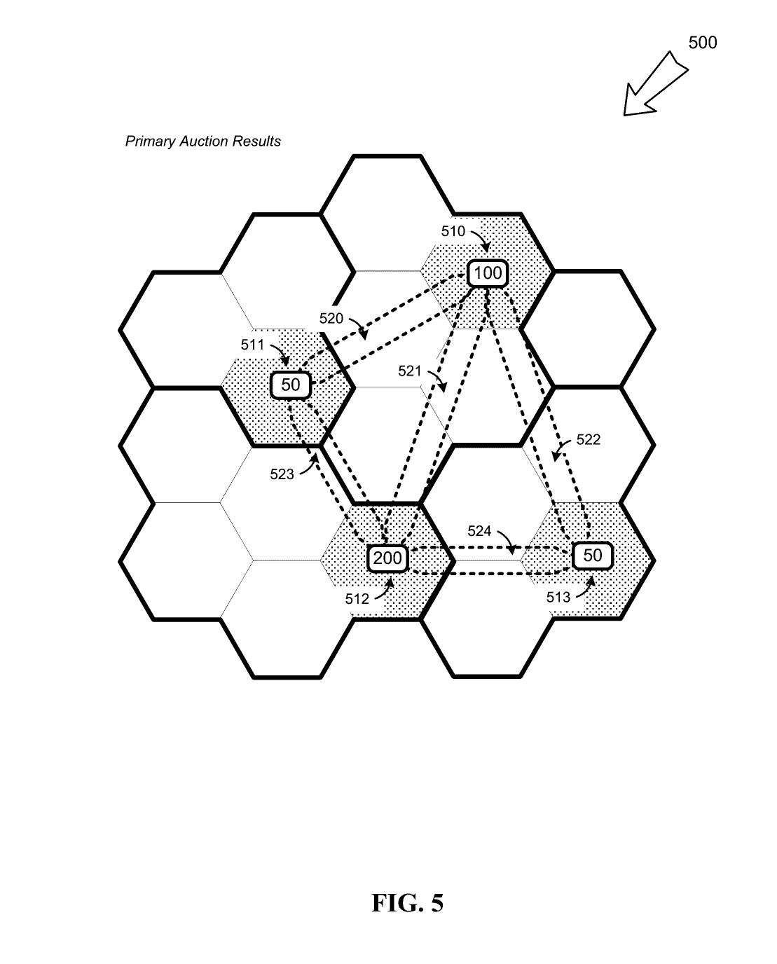

Referring to FIG. 5 an example implementation of the previously described methods is shown where the results of a spectrum primary auction are plotted on a geographic map and a Delaunay triangulation strategy is applied. In the example 500, which is described in conjunction with FIG. 2 and FIG. 4, the geographic centroid coordinates for each of the various license transactions 220 is made a point in the triangulation and the license's respective transaction prices 510, 511, 512, 513 are placed onto a partitioned geographic map. Note that the map is partitioned to match to the relevant license partitioning strategy. A plurality of chords 520, 521, 522, 523, 524 may be identified from the triangulation. Each of the drawn chords may then be used as lines along which a linear interpolation may occur or, taken together, as a surface upon which a multivariate interpolation may occur. By way of interpolation a base price value may be assigned to each of the unpriced (e.g. unsold) license areas.

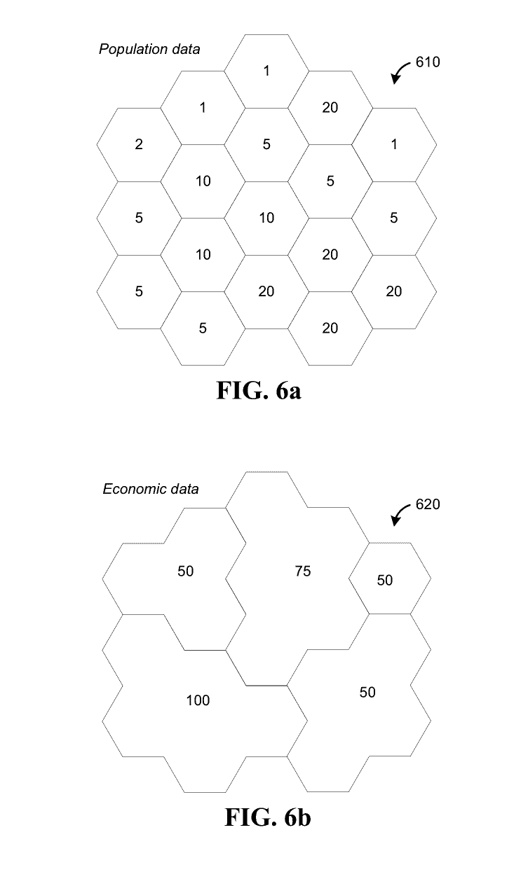

Referring to FIG. 6a and FIG. 6b two geographically partitioned maps are shown containing localized data for the total auction area in FIG. 5. Referring to FIG. 6a a geographic partitioning strategy containing localized population data is shown, and referring to FIG. 6b a different geographic partitioning strategy containing localized economic data is shown. In a preferred embodiment population data 610 is derived from the most recent census information but may be originated from other sources as may be available. Also according to a preferred embodiment regional economic data 620, such as, for example, average household income, may be extracted from the most recent census or other sources as may be available and assigned to a plurality of geographic areas 620 that are defined to match the demographic information.

It will be obvious to anyone generally skilled in the art that the geographic areas describing localized data 610, 620 need not be mutually exclusive. That is: they may be allowed to overlap. The geographic areas also need not align with the partitioning strategy of the primary auction as shown by example in FIG. 5 to be useful. It will also be obvious to anyone generally skilled in the art that various other localized data besides the two examples provided (population and income) may be useful and readily incorporated into a price discovery algorithm. Accordingly, the described method of establishing one or more thematic maps containing localized data may be repeated a plurality of times using various demographic data to create a set of geographic information layers as deep as the implementation may require.

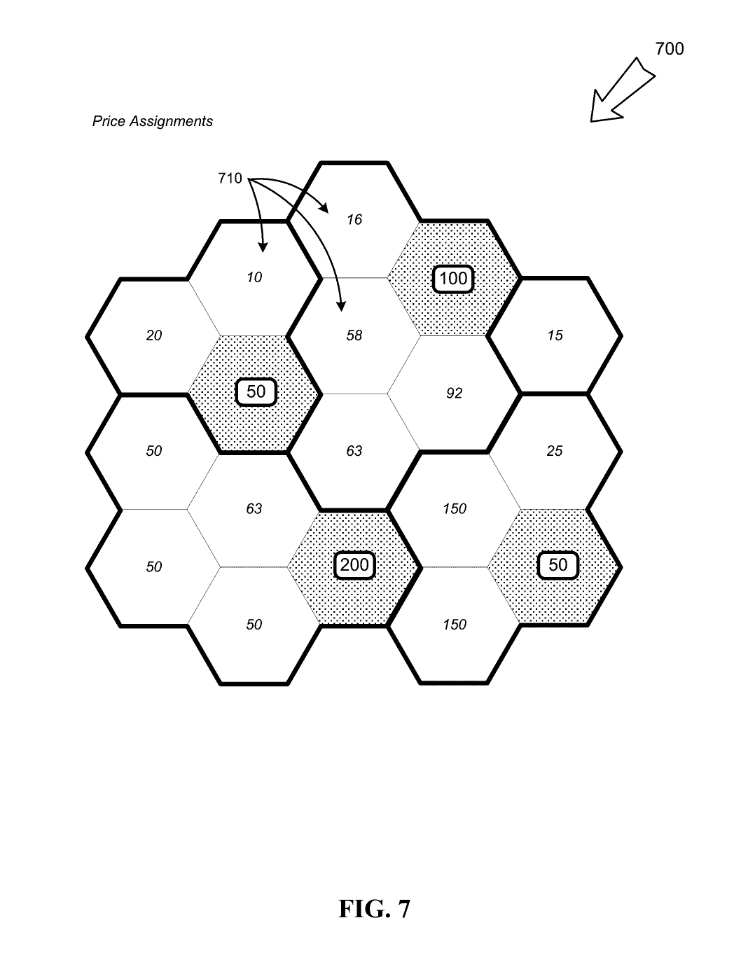

FIG. 7 shows the results of the methods described in 300 and 400 when applied to the example data illustrated in FIG. 5 and FIG. 6a and FIG. 6b. The resultant inventory of spectrum licenses 700 includes a variety of unsold licenses 710 that have been assigned a price calculated by first interpolating from the available transaction price information 510, 511, 512, 513 and then applying price adjustments from the localized data 610, 620.

As may be observed in 700 the assigned prices are similar to the transaction prices, illustrating an aesthetic fairness, and more importantly are also anchored to the underlying localized population and economic data incorporated into the example thereby establishing an objective, predictable price valuation.

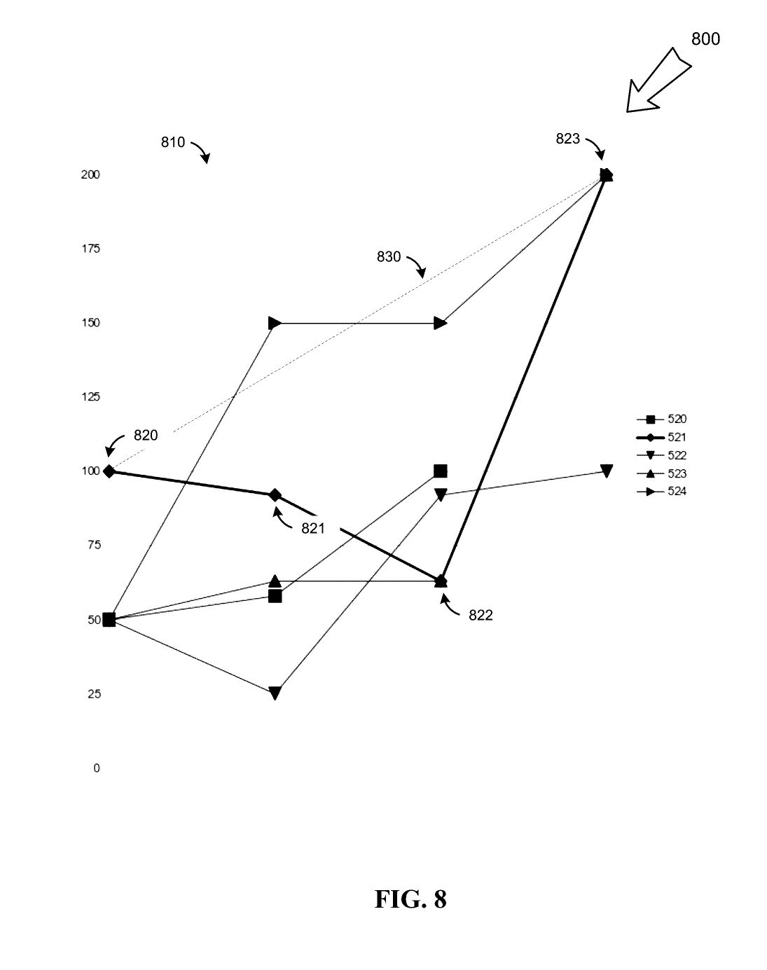

FIG. 8 is a simple analysis of the assigned price values in FIG. 7 sampled along the various chords drawn in FIG. 5. As may be seen in the chart 800 the transaction and assigned prices are plotted in an XY graph to show their relative values and to illustrate how the localized data influences the interpolation. In the chart 800 the calculated prices along a single chord 521 may be observed where the end points 820, 823 are the primary auction transaction prices 510, 512. A simple linear interpolation between the primary auction transaction prices 510, 512 would show a straight line 830, yet in the provided example the localized data 610, 620 has provided a negative adjustment to the interpolated price to generate lower final price values 821, 822.

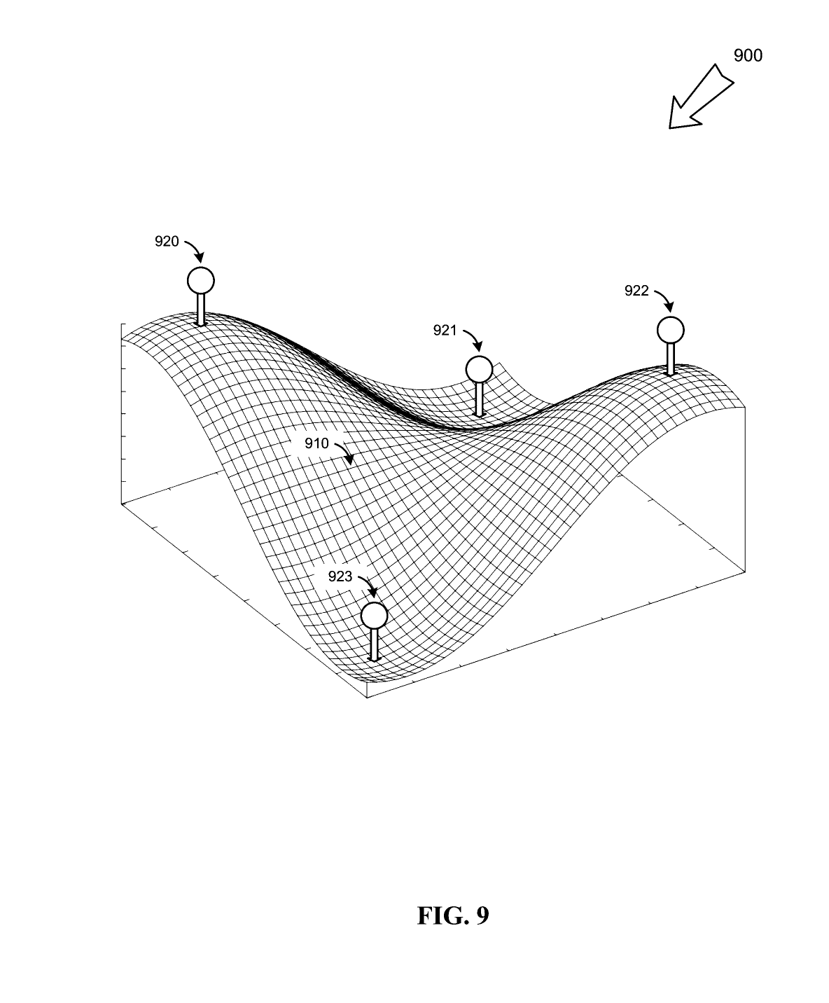

Referring to FIG. 9 it may be immediately obvious how a multivariate interpolation method may be used for price estimation across a large area with geographically sparse transaction data. For illustrative example in the plot 900 four license transactions 920, 921, 922, 923 are produced and a corresponding interpolated 2-dimensional surface 910 is created. An interpolated price for the plurality of other envisioned licenses may be readily calculated by interpolating between the transaction points. According to a preferred embodiment the interpolated price of a given license would simply be the elevation level of the 2-dimensional “pricing” surface at the respective license's centroid position.

It should now be appreciated how a secondary market may discover and assign a price to a plurality of spectrum licenses from the combination of previous, possibly sparse, transaction data, calculated metrics about the spectrum, and a variety of localized datasets. In the various provided examples a general strategy of interpolation between established prices is considered. It will be obvious to anyone generally skilled in the art that the methods and strategies described must also include extrapolation to reach geographic areas not contained within or between the available license areas and positions. Accordingly, while only interpolation is described in the examples this is only for clarity of the examples and the various methods for extrapolation are also included in the invention.

It should also be appreciated that embodiments of the present invention may include apparatuses and/or devices for performing the operations herein. An apparatus may be specially constructed for the desired purposes, or it may comprise a general purpose device selectively activated or reconfigured by a program stored in the device. Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, an exemplary machine-readable storage medium may include, e.g., but not limited to, read only memory (ROM); random access memory (RAM); magnetic disk storage media; optical storage media; magneto-optical storage media; flash memory devices; etc.

One of ordinary skill in the art should readily recognize that the various processes described herein may be implemented by one or a combination of hardware, firmware, and software. Thus a description of a process is likewise a description of an apparatus for performing the process.

Although a variety of examples and other information was used to explain aspects within the scope of the appended claims no limitation of the claims should be implied based on particular features or arrangements in such examples as one of ordinary skill would be able to use these examples to derive a wide variety of implementations. Further, and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

A variety of implementations of the invention have been described. Nevertheless it is expected that various modifications may be introduced without departing from the spirit and scope of the invention. For example, the various other localized data and data sources may be readily incorporated into the price estimation calculation strategy without diverging from the described method. Accordingly, other embodiments are within the scope of the following claims.

1) A method for discovering the price of a spectrum license, the method comprising:
a) receiving input data comprising a plurality of executed spectrum license transactions, each license transaction describing at least (1) a radio frequency band and (2) a geographic area and (3) a transaction price;
b) processing the input data to establish a two-dimensional surface using the geographic and price components within each of the plurality of executed spectrum license transactions, wherein the elevation component of the surface is the transaction price;
c) assigning a initial value to an unsold spectrum license by processing one or more of the executed spectrum license transactions along the established two dimensional surface;
d) processing the input data to also establish at least one or more metric values about the spectrum;
e) adjusting the assigned initial value by combining the at least one or more calculated metric values with a corresponding value from a localized dataset;
f) publishing the adjusted value as the market price.

2) The method of claim 1 wherein receiving the input data comprises receiving the input data from a primary spectrum auction.

3) The method of claim 1 wherein receiving the input data comprises receiving the input data from a secondary spectrum market.

4) The method of claim 1 wherein assigning a initial value comprises a geographic interpolation between two or more of the executed spectrum license transactions.

5) The method of claim 1 wherein assigning a initial value comprises a geographic extrapolation from two or more of the executed spectrum license transactions.

6) The method of claim 1 wherein processing the input data comprises establishing a two-dimensional surface according to a Delauney triangulation and wherein the points of such triangulation are the geographic centroids of the various transacted spectrum license areas.

7) The method of claim 1 wherein processing the input data comprises calculating a Price per MhzPop metric.

8) The method of claim 7 wherein an average Price per MhzPop metric is persistently calculated and published as a market index indicator.

9) A computerized system to discover the price of a spectrum license, the system comprising:
a) an interface to receive input data comprising a plurality of executed spectrum license transactions
b) an interface to receive input data comprising a plurality of localized datasets;
c) an application configured to process the geographic and price components within each of the plurality of executed spectrum license transactions to establish a two-dimensional surface, wherein the elevation component of the surface is the transaction price;
d) an application configured to process the geographic and price components within each of the plurality of executed spectrum license transactions to establish one or more metrics related to the spectrum;
e) an application configured to calculate the price of a spectrum license by:
i) first assigning a base value to the spectrum license;
ii) iteratively adjusting the assigned base value of the spectrum license for each applicable metric value by:
(1) retrieving the previously calculated spectrum metric value;
(2) retrieving a corresponding localized data value;
(3) combining the metric value and the corresponding localized data value to determine a price adjustment value;
(4) increasing or decreasing the base value of the spectrum license according to the adjustment value;
iii) publishing the final value as the license market price.

10) The system of claim 9 wherein the application is configured to assign a base value to a spectrum license by interpolation along the two-dimensional surface.

11) The system of claim 9 wherein the application is configured to assign a base value to a spectrum license by extrapolation along the two-dimensional surface.

12) The system of claim 9 wherein an application publishes one or more of the calculated metrics related to the spectrum as a market index indicator.
